(19) United States
(12) Patent Application Publication
(10) Pub. No.: US 2017/0297822 A1
(43) Pub. Date: Oct. 19, 2017

(54) CARGO CONVEYOR FOR A VEHICLE

(71) Applicant: GM GLOBAL TECHNOLOGY OPERATIONS LLC, Detroit, MI (US)

(72) Inventor: Oscar Manuel Roldan Gonzalez, Toluca (MX)

(73) Assignee: GM GLOBAL TECHNOLOGY OPERATIONS LLC, Detroit, MI (US)

(21) Appl. No.: 15/132,608

(22) Filed: Apr. 19, 2016

(51) Int. Cl. B65G 15/28; B65G 67/08; B65G 43/00; B65G 67/24; B60P 1/36

(52) U.S. Cl. CPC B65G 15/28; B65G 67/24; B60P 1/36; B65G 43/00; B65G 67/08

(57) ABSTRACT

A cargo conveyor is provided for a vehicle having an interior including a cargo area having a floor, a wall, a reach zone, and a distant zone and configured to transport a cargo item. The cargo conveyor includes a conveyor belt, a motor, and a controller. The conveyor belt is connectable to the cargo area and has a top portion. The motor is connectable to the cargo area, operatively connected to the conveyor belt, and configured to move the top portion of the conveyor belt in a forward direction and in a rearward direction. The controller is in communication with the motor and is configured to control the motor. The cargo conveyor is configured to selectively move the cargo item from the reach zone to the distant zone and from the distant zone to the reach zone.

### TECHNICAL FIELD

This disclosure relates to a cargo conveyor for a vehicle.

### BACKGROUND

A vehicle typically includes a cargo area for transporting cargo items, such as suitcases, groceries, tools, equipment, boxes, bags, etc. in the vehicle. It may be difficult for an operator to load cargo items in and unload cargo items from a distant zone of the cargo area, outside of an easily accessible reach zone of the cargo area.

### SUMMARY

A cargo conveyor and a vehicle are disclosed herein. The cargo conveyor is for a vehicle having an interior including a cargo area having a floor, a wall, a reach zone, and a distant zone and configured to transport a cargo item. The cargo conveyor includes a conveyor belt, a motor, and a controller. The conveyor belt is connectable to the cargo area and has a top portion. The motor is connectable to the cargo area, operatively connected to the conveyor belt, and configured to move the top portion of the conveyor belt in a forward direction and in a rearward direction. The controller is in communication with the motor and is configured to control the motor. The cargo conveyor is configured to selectively move the cargo item from the reach zone to the distant zone and from the distant zone to the reach zone.

The vehicle includes an interior and a cargo conveyor. The interior has a cargo area including a floor, a side panel, a reach zone, and a distant zone and is configured to transport a cargo item. The cargo conveyor has a conveyor belt, a motor, and a controller. The conveyor belt is connected to the cargo area and has a top portion. The motor is connected to the cargo area, operatively connected to the conveyor belt, and configured to move the top portion of the conveyor belt in a forward direction and in a rearward direction. The controller is in communication with the motor and is configured to control the motor. The cargo conveyor is configured to selectively move the cargo item from the reach zone to the distant zone and from the distant zone to the reach zone.

The cargo conveyor and the vehicle disclosed herein allow an operator to load a cargo item on the conveyor belt in an easily accessible reach zone of the cargo area, move the cargo item from the reach zone to a distant zone of the cargo area, outside of the easily accessible reach zone, for transport, and move the cargo item from the distant zone to the reach zone to unload the cargo item from the conveyor belt in the easily accessible reach zone. This disclosure applies to any vehicle or mobile platform, including but not limited to cars, trucks, vans, all-terrain vehicles, busses, boats, trains, airplanes, manufacturing vehicles and equipment, agricultural vehicles and equipment, construction vehicles and equipment, maintenance vehicles and equipment, military vehicles and equipment, etc.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a fragmentary, schematic, perspective illustration of a vehicle having a cargo conveyor.

FIG. 2 is a schematic, perspective, cross-sectional illustration, partially in elevation, of the vehicle of FIG. 1, taken at the center of the cargo conveyor, with portions of the vehicle removed for clarity.

FIG. 3 is a fragmentary, schematic, perspective illustration of the vehicle of FIG. 1, with portions of the vehicle and a conveyor belt of the cargo conveyor removed for clarity.

FIG. 4 is a fragmentary, schematic, perspective illustration, in the area of circle 4 of FIG. 3, of the cargo conveyor of FIG. 1 with the conveyor belt removed for clarity.

FIG. 5A is a schematic, perspective illustration of a main body of the cargo conveyor of FIG. 1, viewed from above.

FIG. 5B is a schematic, perspective illustration of the main body of the cargo conveyor of FIG. 1, viewed from below.

FIG. 6 is a fragmentary, schematic, perspective, exploded illustration of the cargo conveyor of FIG. 1.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims.

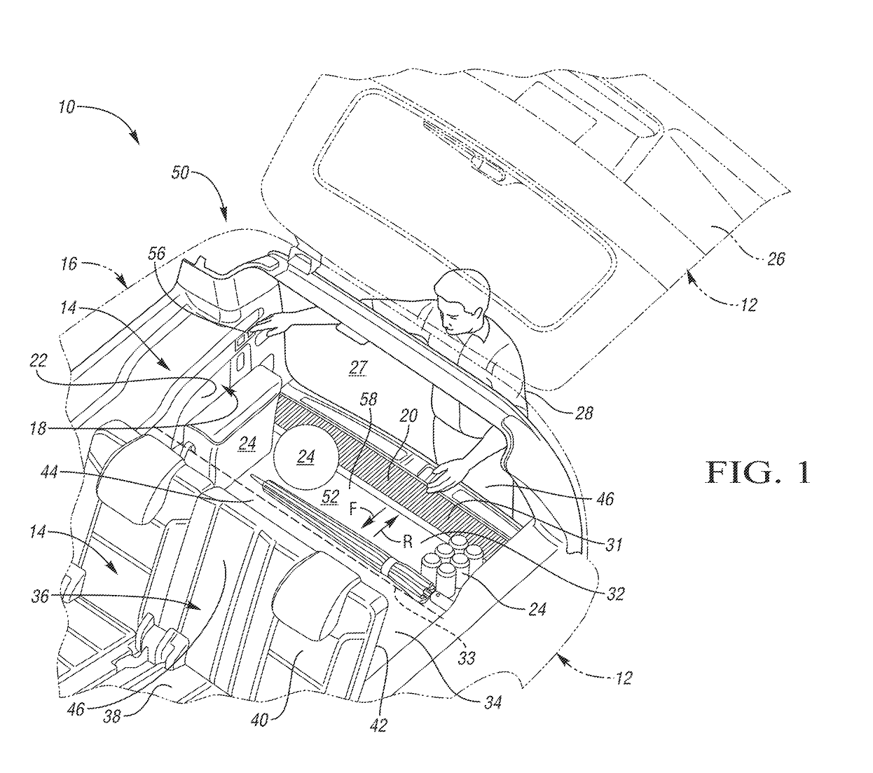

Referring to the drawings, wherein like reference numbers refer to like components throughout the views, FIG. 1 shows an example vehicle 10. The vehicle 10 includes a cargo conveyor 50 of the type disclosed herein. The vehicle 10 includes a body 12. The body 12 defines an interior 14 and an exterior 16 of the vehicle 10. The interior 14 of the vehicle 10 includes a cargo area 18 having a floor 20 and a side panel or wall 22. The cargo area 18 is defined herein as the portion of the interior 14 of the vehicle 10 configured to transport a cargo item 24, such as a suitcase, a grocery item, a tool, a piece of equipment, a box, a bag, etc. in the interior 14 of the vehicle 10.

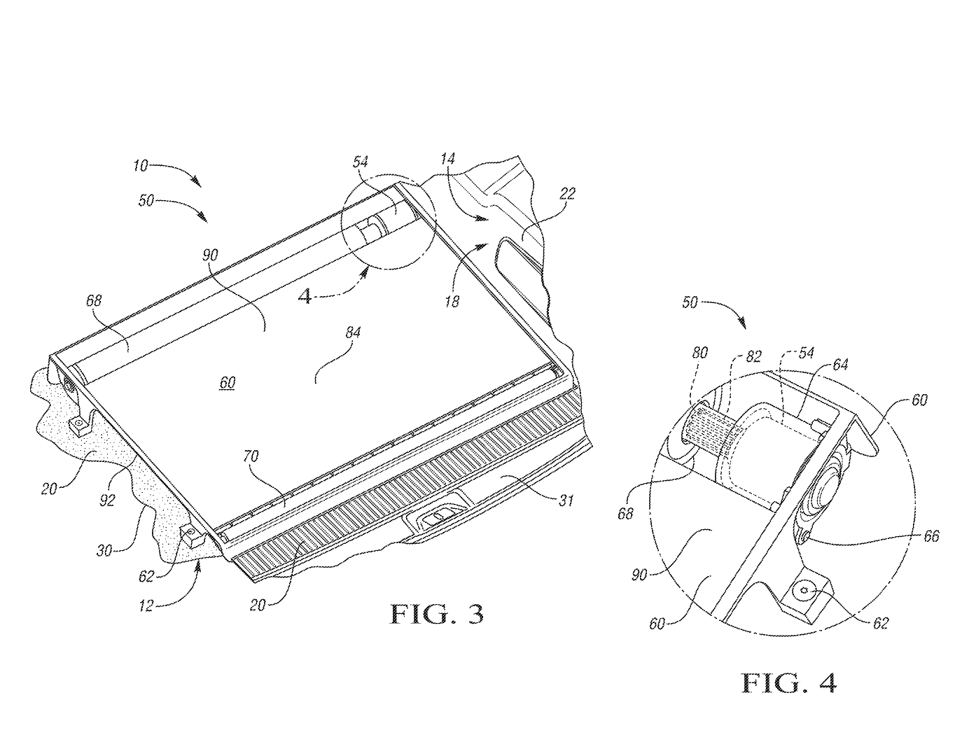

The body 12 includes an openable closure 26 to provide access to the cargo area 18 and to the cargo item 24 in the cargo area 18 by an operator 28 of the vehicle 10 when the openable closure 26 is in an open position, as shown. The openable closure 26 may be a lift gate, as shown, a single door, a double door, a swing gate, a drop gate, a window, or any outer openable closure 26. The body 12 is configured to form an opening 27 in the body 12 when the openable closure 26 is in the open position, as shown. The body 12 may include a floor pan 30, as best seen in FIG. 3, made of a sheet metal, such as steel or aluminum, or of any other suitable structural material. The floor 20 of the cargo area 18 may include the floor pan 30 of the body 12. Referring again to FIG. 1, the floor 20 of the cargo area 18 may include a sill plate 31 disposed under the openable closure 26 when the openable closure 26 is in a closed position (not shown).

Continuing to refer to FIG. 1, the cargo area 18 has reach zone 32 and a distant zone 34. The reach zone 32 has a boundary 33, located between the reach zone 32 and the distant zone 34. The reach zone 32 is defined herein as the portion of the cargo area 18 that is easily accessible by the operator 28 of the vehicle 10 when the operator 28 is loading or unloading the cargo item 24 in the cargo area 18. The reach zone 32 of the cargo area 18 may be the portion of the cargo area 18 where the operator 28 can load or unload the cargo item 24 without bending at the waist of the operator 28 or without entering the vehicle 10 with anything other than the arms of the operator 28. The distant zone 34 of the cargo area 18 is defined herein as the portion of the cargo area 18 that is outside of the easily accessible reach zone 32. The distant zone 34 of the cargo area 18 may be the portion of the cargo area 18 where the operator 28 cannot load or unload a cargo item 24 without bending at the waist of the operator 28 or without entering the vehicle 10 with anything other than the arms of the operator 28.

The interior 14 of the vehicle 10 may include a passenger area 36 having a seat 38. The passenger area 36 is defined herein as the portion of the interior 14 of the vehicle 10 where the operator 28 and a passenger (not shown), if any, sit when the vehicle 10 is being operated. The seat 38 may be a bench seat, as shown, a row of bucket seats, or may be any other type of seat or seats, as appropriate. The seat 38 may have a seat back 40 having a rear surface 42.

The cargo area 18 may be a rear cargo area, as shown, disposed behind the seat 38. The cargo area 18 may include the rear surface 42 of the seat back 40. The cargo area 18 may be open to the passenger area 36 at an opening 44 above the seat 38. The interior 14 of the vehicle may enclose a single space 46, with no complete walls or separations, as shown. The single space 46 may be enclosed by the passenger area 36 and the cargo area 18 of the interior 14, as shown. There may be no complete wall or separation between the passenger area 36 and the cargo area 18 of the interior 14, as shown.

Referring now to FIGS. 1-4, the cargo conveyor 50 includes a conveyor belt 52, a motor 54, and a controller 56. The conveyor belt 52 is operatively connected to the cargo area 18 and has an upper or top portion 58. The upper or top portion 58 of the conveyor belt 52 is that part of the conveyor belt 52 on which the cargo item 24 may rest in either the reach zone 32 or distant zone 34 of the cargo area 18. The conveyor belt 52 may be arranged in a continuous loop, as shown. Alternatively, the conveyor belt 52 may be arranged as a single sheet. The conveyor belt 52 may be made of a flexible material. For example, the conveyor belt may include one of a rubber material, a plastic material, a woven fabric, and a carpet. The conveyor belt 52 may include any other suitable material.

The motor 54 is connectable to the cargo area 18, is operatively connected to the conveyor belt 52, and is configured to move the top portion 58 of the conveyor belt 52 in a forward direction (arrow F) and in a rearward direction (arrow R), opposite of the forward direction (arrow F). The motor 54 may be an electric motor, such as a DC Motor, an AC motor, a stepper motor, an induction motor, or any other suitable electric motor.

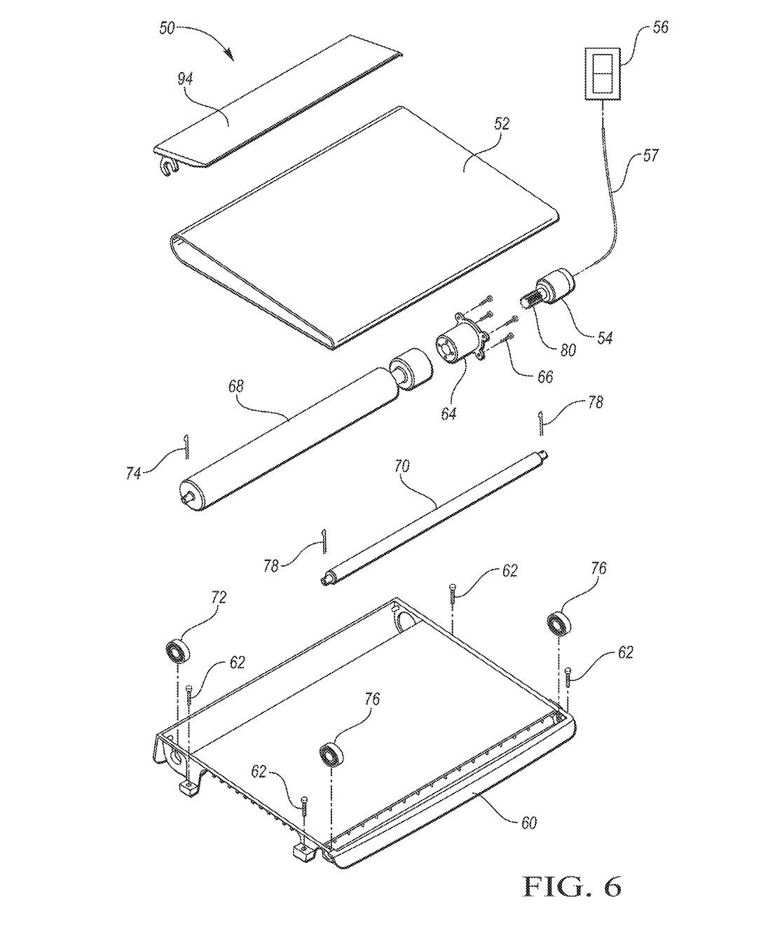

The controller 56 is in communication with the motor 54 and is configured to control the motor 54. The controller 56 may include a switch, as shown. The switch may be connected to one of the side panel or wall 22 and the floor 20 of the cargo area 18, as shown. The switch may be mounted on the side panel or wall 22 of the cargo area 18 proximate to the openable closure 26 such that the operator 28 can easily access the switch when loading the cargo item 24 in the cargo area 18 or when unloading the cargo item 24 from the cargo area 18. Alternatively, the switch may be mounted on the floor 20 of the cargo area 18 proximate to the openable closure 26 such that the operator 28 can easily access the switch when loading the cargo item 24 in the cargo area 18 or when unloading the cargo item 24 from the cargo area 18. The switch may be mounted in any other location in the cargo area 18 such that the operator 28 can easily access the switch when loading or unloading the cargo item 24 in the cargo area 18. The controller 56 may be connected to the motor 54 via a wire 57, as best seen in FIG. 6.

Referring again to FIGS. 1-4, the cargo conveyor 50 is configured to selectively move the cargo item 24 from the reach zone 32 to the distant zone 34 and from the distant zone 34 to the reach zone 32. The cargo conveyor 50 may be configured to selectively move the cargo item 24 from the reach zone 32 to the distant zone 34 and from the distant zone 34 to the reach zone 32 when the operator 28 operates the switch. Thus, the operator 28 may load the cargo item 24 on the top portion 58 of the conveyor belt 52 in the easily accessible reach zone 32 of the cargo area 18. Then, if desired, the operator 28 may move the cargo item 24 from the reach zone 32 to the distant zone 34 of the cargo area 18 via the cargo conveyor 50 for loading of additional cargo items or for transport. Finally, the operator 28 may move the cargo item 24 from the distant zone 34 to the easily accessible reach zone 32 of the cargo area 18 via the cargo conveyor 50 for unloading of the cargo item 24.

The switch of the controller 56 may have a first position (not shown) configured to control the motor 54 such that the top portion 58 of the conveyor belt 52 moves in one of the forward direction (arrow F) and the rearward direction (arrow R). The switch may have a second position (not shown) configured to control the motor 54 such that the top portion 58 of the conveyor belt 52 moves in the other of the forward direction (arrow F) and the rearward direction (arrow R). The switch may have a third position (not shown) configured to control the motor 54 such that movement of the top portion 58 of the conveyor belt 52 is prevented. The third position of the switch may be a default position of the switch when the switch is not placed in one of the first position and the second position by the operator 28. The switch may be a three position toggle switch, as shown in FIG. 6, a plurality of push buttons, as shown in FIG. 1, or any other suitable switch that can be conveniently operated by the operator 28 of the vehicle 10. Referring again to FIGS. 1-4, the motor 54 may not be powered when the switch is in the third position. The motor 54 may be further configured to prevent movement of the conveyor belt 52 when the motor 54 is not powered.

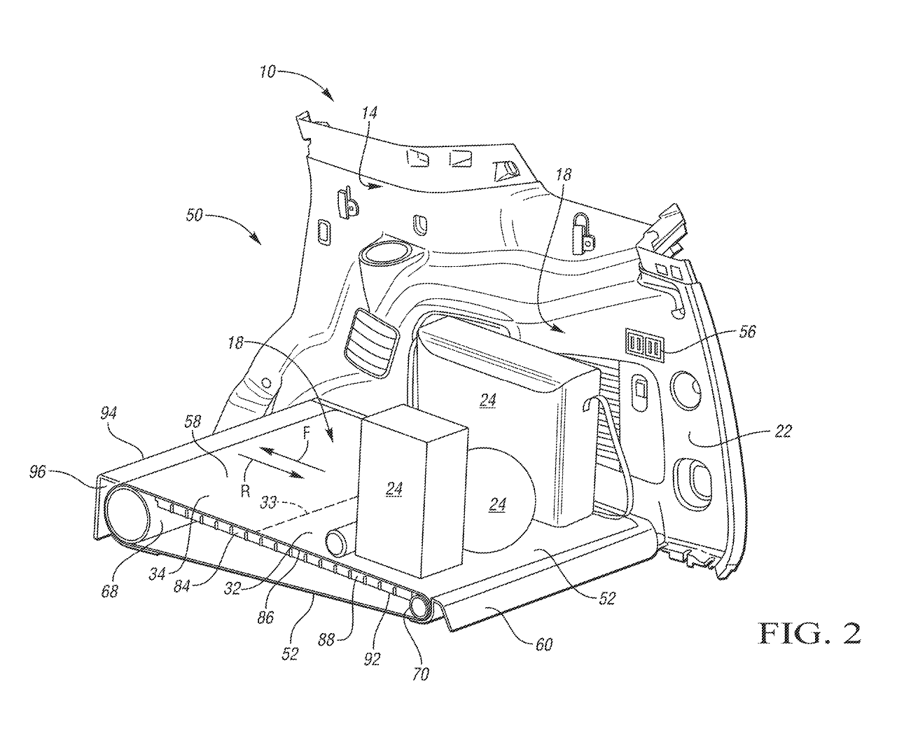

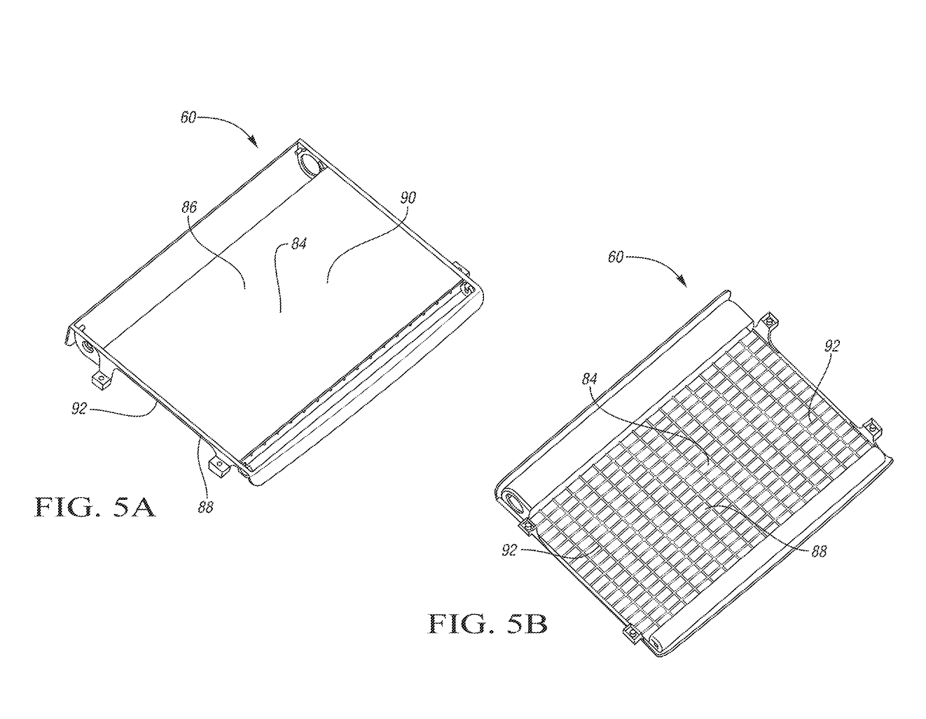

Referring now to FIGS. 2-6, the cargo conveyor 50 may include a main body 60. The main body 60 of the cargo conveyor 50 may be connected to the cargo area 18, attached to the motor 54, and operatively connected to the conveyor belt 52. The main body 60 may be made of a molded plastic material or any other suitable material. The main body 60 may be connected to the floor 20 of the cargo area 18 via one or more main body fasteners 62. The main body 60 may be connected to the floor pan 30 of the body 12 via the main body fasteners 62. The main body fasteners 62 may be mechanical fasteners, as shown, or any other suitable fastener. The motor 54 may be attached to the main body 60 via a motor bracket 64 and one or more motor fasteners 66. The motor fasteners 66 may be mechanical fasteners, as shown, or any other suitable fastener.

The cargo conveyor 50 may include a rotatable drive roller 68 and a rotatable idler roller 70. The drive roller 68 may be rotatably connected to the main body 60 and operatively connected to the motor 54 and to the conveyor belt 52. The idler roller 70 may be rotatably connected to the main body 60 and operatively connected to the conveyor belt 52. The drive roller 68 may be rotatably connected to the main body 60 via a first bearing 72 and a first clip 74. The idler roller 70 may be rotatably connected to the main body 60 via one or more second bearings 76 and one or more second clips 78. Additional drive rollers 68 and idler rollers 70 may be used as appropriate.

The motor 54 may include an output gear 80. The output gear 80 may be an external gear, as shown. The drive roller 68 may include an input gear 82 configured to engage with the output gear 80 to connect the motor 54 to the drive roller 68. The input gear 82 may be an internal gear, as shown. Other configurations of gears, connections, and/or engagements between the motor 54 and the drive roller 68 may be used as appropriate. The conveyor belt 52 may be a circumambient pad surrounding and supported by the drive roller 68 and the idler roller 70, as best seen in FIG. 2.

Continuing to refer to FIGS. 2-6, the main body 60 may be configured to support the top portion 58 of the conveyor belt 52 and the cargo item 24 on the top portion 58 of the conveyor belt 52. The main body 60 may include a support portion 84. The support portion 84 may have an upper portion 86 and a lower portion 88. The upper portion 86 may include a smooth top surface 90. The lower portion 88 may include a support rib 92 or any other suitable support feature. The top portion 58 of the conveyor belt 52 may be disposed above the support portion 84 of the main body 60. The top portion 58 of the conveyor belt 52 may be slideably moveable in the forward direction (arrow F) and in the rearward direction (arrow R) on the smooth top surface 90 of the support portion 84 of the main body 60. The lower portion 88 together with the upper portion 86 of the support portion 84 may support the top portion 58 of the conveyor belt 52 and the cargo item 24 on the top portion 58 of the conveyor belt 52.

The cargo conveyor may include a top cap 94. The top cap 94 may be connected to one of the main body 60 of the cargo conveyor 50 and the interior 14 of the vehicle 10. The top cap 94 may be configured to cover a space 96 formed between the conveyor belt 52 and the cargo area 18 of the vehicle 10. The top cap 94 may be used at the front of the conveyor belt 52, as shown. Alternatively, the top cap 94 may be used at the rear of the conveyor belt 52. The top cap 94 may be configured to prevent the cargo items 24 from moving or falling off of the top portion 58 of the conveyor belt 52 when the top portion 58 of the conveyor belt 52 moves in one of the forward direction (arrow F) and the rearward direction (arrow R). The cargo conveyor 50 may be configured to cooperate with the sill plate 31 such that the cargo items 24 are prevented from moving or falling off of the top portion 58 of the conveyor belt 52 by the sill plate 31 when the top portion 58 of the conveyor belt 52 moves in the rearward direction (arrow R).

While the best modes for carrying out the many aspects of the present teachings have been described in detail, those familiar with the art to which these teachings relate will recognize various alternative aspects for practicing the present teachings that are within the scope of the appended claims.

1. A cargo conveyor for a vehicle having an interior including a cargo area having a floor, a wall, a reach zone, and a distant zone and configured to transport a cargo item, the cargo conveyor comprising:
a conveyor belt connectable to the cargo area; wherein the conveyor belt has a top portion;
a motor connectable to the cargo area, operatively connected to the conveyor belt, and configured to move the top portion of the conveyor belt in a forward direction and in a rearward direction; and
a controller in communication with the motor and configured to control the motor;
wherein the cargo conveyor is configured to selectively move the cargo item from the reach zone to the distant zone and from the distant zone to the reach zone.

2. The cargo conveyor of claim 1, wherein the motor is an electric motor;
wherein the controller includes a switch having a first position, and second position, and a third position;
wherein the first position is configured to control the motor such that the top portion of the conveyor belt moves in one of the forward direction and the rearward direction;
wherein the second position is configured to control the motor such that the top portion of the conveyor belt moves in the other of the forward direction and the rearward direction; and
wherein the third position is configured to control the motor such that movement of the top portion of the conveyor belt is prevented.

3. The cargo conveyor of claim 2, wherein the switch is connectable to one of the wall and the floor of the cargo area;
wherein the motor is not powered when the switch is in the third position; and
wherein the motor is further configured to prevent movement of the conveyor belt when the motor is not powered.

4. The cargo conveyor of 1, further comprising a main body;
wherein the main body is connectable to the cargo area, attached to the motor, and operatively connected to the conveyor belt; and
wherein the main body is configured to support the top portion of the conveyor belt and the cargo item on the top portion of the conveyor belt.

5. The cargo conveyor of claim 4, wherein the main body is connectable to the floor of the cargo area.

6. The cargo conveyor of claim 4, further comprising a rotatable drive roller and a rotatable idler roller;
wherein the drive roller is rotatably connected to the main body and operatively connected to the motor and the conveyor belt; and
wherein the idler roller is rotatably connected to the main body and operatively connected to the conveyor belt.

7. The cargo conveyor of claim 6, wherein the conveyor belt is a circumambient pad surrounding and further supported by the drive and idler rollers.

8. The cargo conveyor of claim 4, further comprising a top cap;
wherein the top cap is connected to one of the main body of the cargo conveyor and the interior of the vehicle; and
wherein the top cap is configured to cover a space formed between the conveyor belt and the cargo area of the vehicle.

9. The cargo conveyor of claim 1, wherein the conveyor belt includes one of a woven fabric and a carpet.

10. A vehicle, comprising:
an interior including a cargo area having a floor, a side panel, a reach zone, and a distant zone and configured to transport a cargo item; and
a cargo conveyor, including:
a conveyor belt connected to the cargo area; wherein the conveyor belt has a top portion;
a motor connected to the cargo area, operatively connected to the conveyor belt, and configured to move the top portion of the conveyor belt in a forward direction and in a rearward direction; and
a controller in communication with the motor and configured to control the motor;
wherein the cargo conveyor is configured to selectively move the cargo item from the reach zone to the distant zone and from the distant zone to the reach zone.

11. The vehicle of claim 10, wherein the interior of the vehicle further includes a passenger area having a seat;
wherein the cargo area is a rear cargo area disposed behind the seat; and
wherein the rear cargo area is open to the passenger area above the seat.

12. The vehicle of claim 11, wherein the seat includes a seat back having a rear surface; and
wherein the rear cargo area includes the rear surface of the seat back.

13. The vehicle of claim 10, wherein the motor is an electric motor;
wherein the controller includes a switch having a first position, a second position, and a third position,
wherein the first position is configured to control the motor such that the top portion of the conveyor belt moves in one of the forward direction and the rearward direction;
wherein the second position is configured to control the motor such that the top portion of the conveyor belt moves in the other of the forward direction and the rearward direction; and
wherein the third position is configured to control the motor such that motion of the top portion of the conveyor belt is prevented.

14. The vehicle of claim 13, wherein the motor is not powered when the switch in the third position; and
wherein the motor is further configured to prevent motion of the conveyor belt when the motor is not powered.

15. The vehicle of claim 13, wherein the cargo area further includes an openable closure; and
wherein the switch is mounted on the side panel proximate to the openable closure.

16. The vehicle of claim 13, wherein the cargo area further includes a openable closure; and
wherein the switch is mounted on the floor proximate to the openable closure.

17. The vehicle of claim 10, wherein the cargo conveyor further includes a main body;
wherein the main body is connected to the cargo area, attached to the motor, and operatively connected to the conveyor belt; and
wherein the main body is configured to support the top portion of the conveyor belt and the cargo item on the top portion of the conveyor belt.

18. The vehicle of claim 17, wherein the main body is connected to the floor of the cargo area.

19. The vehicle of claim 18, wherein the vehicle further comprises a body having a floor pan;
wherein the floor of the cargo area includes the floor pan of the body; and
wherein the main body is connected to the floor of the cargo area.

20. The vehicle of claim 11, wherein the interior of the vehicle encloses a single space.
